(19) United States
(12) Patent Application Publication
(10) Pub. No.: US 2026/0326354 A1
(43) Pub. Date: Oct. 22, 2026

(54) HEATED MOLD ASSEMBLY CONFIGURED TO FORM COMPLEX GEOMETRIES

(71) Applicant: GM GLOBAL TECHNOLOGY OPERATIONS LLC, Detroit, MI (US)

(72) Inventors: Israel LOPEZ-GONZALEZ, Warren, MI (US); Ramon Andres CORDERO, Sterling Heights, MI (US); Jaime S. HOLLATZ, Clarkston, MI (US)

(21) Appl. No.: 19/183,207

(22) Filed: Apr. 18, 2025

(51) Int. Cl. B29C 45/73; B29C 45/37; B29L 31/34

(52) U.S. Cl. CPC B29C 45/7312; B29C 45/372; B29L 2031/3418

(57) ABSTRACT

An injection molding system including: a cavity plate configured to cooperate with a core plate to form a part therebetween by injection molding; a forming surface of the cavity plate configured as a negative of an external side of the part to form an external shape and external features of the part; cooling lines within the cavity plate; and heaters within the cavity plate between the forming surface and the cooling lines.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a heated mold assembly configured to form parts having complex geometries.

Injection molding is a manufacturing process used to produce parts by injecting molten material, typically plastic, into a mold. The process includes feeding plastic pellets into a heated barrel where the pellets are melted into a liquid state. The molten plastic is then injected under high pressure through a nozzle into a mold cavity. The mold is configured to form the part with the desired shape and features. After the mold cavity is filled, the plastic cools and solidifies. Cooling channels within the mold help manage the temperature to ensure that the material sets properly and to reduce cycle times. After the plastic solidifies, the mold opens and ejector pins push the newly formed part out of the mold. The process then repeats for the next part. Injection molding is used for making parts in various industries, such as the automotive industry and countless non-automotive industries.

### SUMMARY

The present disclosure provides for, in various features, an injection molding system including: a cavity plate configured to cooperate with a core plate to form a part therebetween by injection molding; a forming surface of the cavity plate configured as a negative of an external side of the part to form an external shape and external features of the part; cooling lines within the cavity plate; and heaters within the cavity plate between the forming surface and the cooling lines.

In further features, temperature sensors are adjacent to the heaters.

In further features, the temperature sensors are thermocouples.

In further features, the heaters are electric heaters.

In further features, the heaters are cartridge heaters.

In further features, the cavity plate defines a gate configured for molten plastic to be injected through to the forming surface.

In further features, the forming surface includes surface features configured to form geometric shapes of the part.

In further features, the surface features include a plurality of protrusions; and the forming surface further includes smooth areas configured to form smooth exterior surfaces of the part.

In further features, the plurality of protrusions are configured to form a grill pattern of a speaker cover, and the geometric shapes define first holes extending through the part and second holes having a bottom surface.

In further features, the heaters are restricted to first areas of the cavity plate opposite to the plurality of protrusions such that second areas of the cavity plate opposite to the smooth areas are devoid of the heaters.

In further features, the heaters are configured to heat to 180 °F-200 °F.

The present disclosure also provides for, in various features, an injection molding system including: a cavity plate configured to cooperate with a core plate to form a part therebetween by injection molding; and a forming surface of the cavity plate configured as a negative of an external side of the part, the forming surface including: protrusions configured to form holes in the part; and a smooth area spaced apart from the protrusions configured to form a smooth exterior surface of the part spaced from the holes. Cooling lines are within the cavity plate. Heaters are within the cavity plate beneath the protrusions, and between the protrusions and the cooling lines, the heaters configured to heat molten plastic injected onto the forming surface during molding.

In further features, the heaters are configured to heat to within a temperature range of 180 °F-200 °F.

In further features, temperature sensors are adjacent to the heaters.

In further features, the temperature sensors include thermocouples.

In further features, the heaters include cartridge heaters.

The present disclosure also provides for, in various features, a method for forming a part by injection molding, the method including: heating a forming surface of a cavity plate of a mold assembly with heaters within the cavity plate between the forming surface and cooling lines within the cavity plate; closing the cavity plate and a core plate of the mold assembly together; injecting molten plastic through a gate defined by the cavity plate into an area between the cavity plate and the core plate such that the molten plastic flows onto the forming surface and around protrusions of the forming surface to form holes in the part; cooling the molten plastic with coolant flowing through cooling lines within the cavity plate, the heaters within the cavity plate are between the forming surface and the cooling lines; separating the cavity plate and the core plate; and removing the part from the mold assembly.

In further features, the method includes heating the forming surface with the heaters to 180 °F-200 °F.

In further features, the method includes forming the part as a speaker cover.

In further features, the method includes injecting the molten plastic through the gate onto an unheated, smooth area of the forming surface to form a smooth exterior surface of the part spaced apart from the holes in the part.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a cavity plate of an injection molding system of the present disclosure;

FIG. 2 is a perspective view of the cavity plate of FIG. 1 with an outermost portion of a forming surface removed to show heating elements of the cavity plate;

FIG. 3 is a plan view of FIG. 2;

FIG. 4 is a cross-sectional view of the cavity plate of the present disclosure;

FIGS. 5A-5D illustrate a method and injection molding system in accordance with the present disclosure for forming parts including complex geometries; and

FIG. 6 is a plan view of an exemplary part formed using an injection molding assembly and method in accordance with the present disclosure.

In the drawings, reference numbers may be reused to identify similar and/or identical elements.

### DETAILED DESCRIPTION

The present disclosure is directed to injection molding systems and methods configured for forming “molded in color” parts, which are formed to have any color requested by an original equipment manufacturer (OEM) supplier, customer, etc. Forming a part “molded in color” eliminates any need to paint the part after it is formed. Because the parts are not painted, they must be molded precisely without any irregularities that would be unacceptable on a surface visible after the part is installed (e.g., class A surface).

For example, speaker covers include a class A outer surface defining a plurality of holes. Some of the holes extend entirely through the part and are spaced close together. When the speaker is installed, the closely spaced holes are arranged directly over the speaker. The speaker cover may further include holes that do not extend entirely through the speaker cover, and are outboard of the through holes that cover the actual the speaker. When these outboard holes are formed, weld lines may be visible between the holes due to failure of the molten plastic to evenly flow around protrusions of the mold that define the holes. Such weld lines are typically unacceptable on a surface that is visible after the speaker cover is installed, such as a class A surface.

The present disclosure generally provides for an injection molding system with heaters that are closely adjacent to a forming surface of a cavity plate configured to form holes of a speaker plate. The heaters are closer to the forming surface than cooling lines of the cavity plate. During the molding process, the heaters are configured to heat the forming surface and molten plastic thereon to 180 °F-200 °F, or higher. Heating the molten plastic to such elevated temperatures facilitates flow of the molten plastic around protrusions of the cavity plate configured to form the holes in the speaker plate. Thus, the heaters of the present disclosure are configured to eliminate, or greatly reduce, the occurrence of weld lines on a molded part of complex geometry, such as a speaker cover configured to be installed on a door of an automobile over a speaker. The injection molding systems and methods of the present disclosure are configured to form any other automotive part, or nonautomotive part, of complex geometry “molded in color” and reduce or eliminate the presence of weld lines thereon.

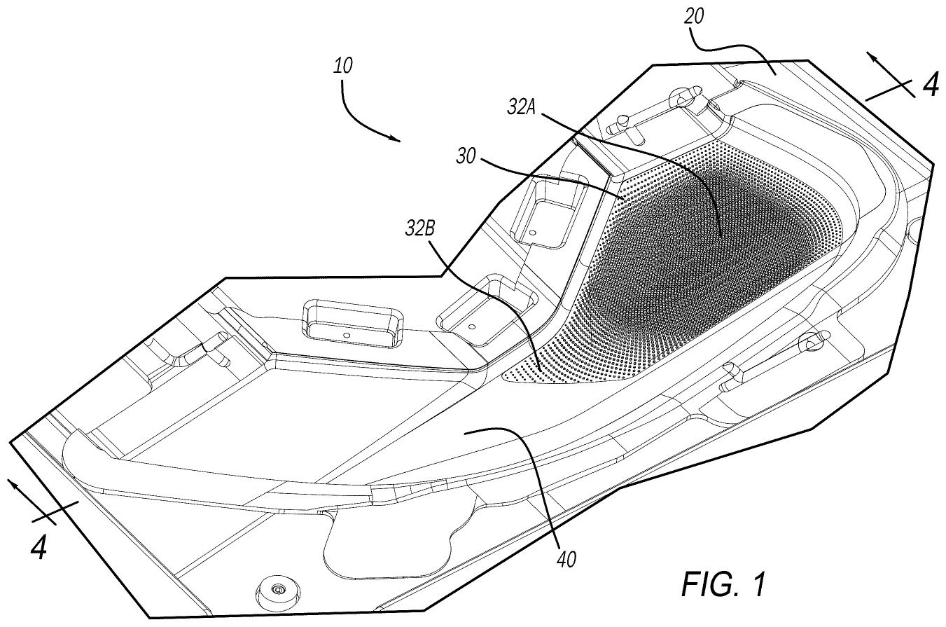

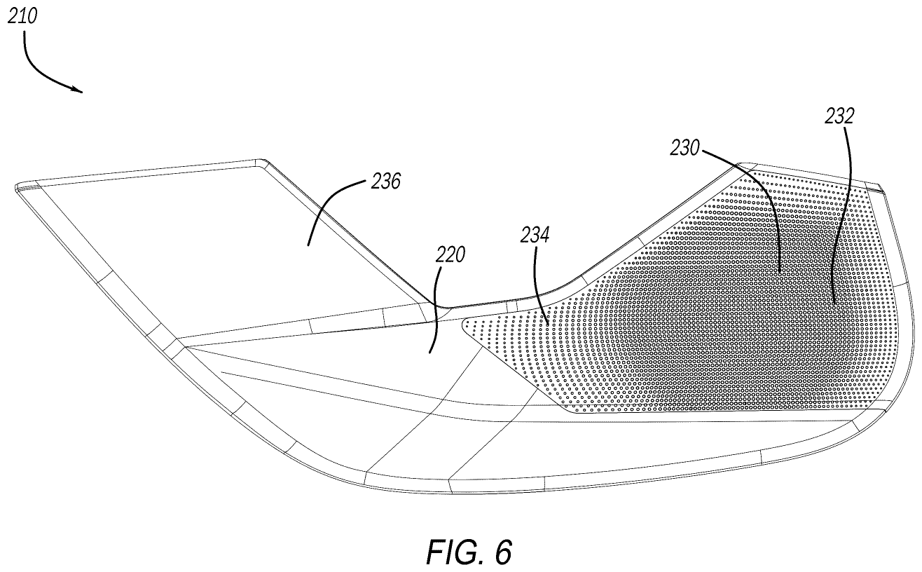

FIG. 1 illustrates an injection molding system 10 in accordance with the present disclosure. The injection molding system 10 may be configured to form any suitable part using any suitable injection molding system process. FIG. 6 illustrates an example of a part 210, which may be formed using the injection molding system 10. As described further herein, the part 210 is a speaker cover for covering an audio speaker. The part 210 is particularly configured to be mounted to a vehicle door over a speaker installed within the door. The part 210 is just one example of a part that may be formed using the injection molding system 10. The injection molding system 10 may be configured to form any other suitable part configured for installation in a vehicle. The injection molding system 10 may be configured for non-automotive applications as well.

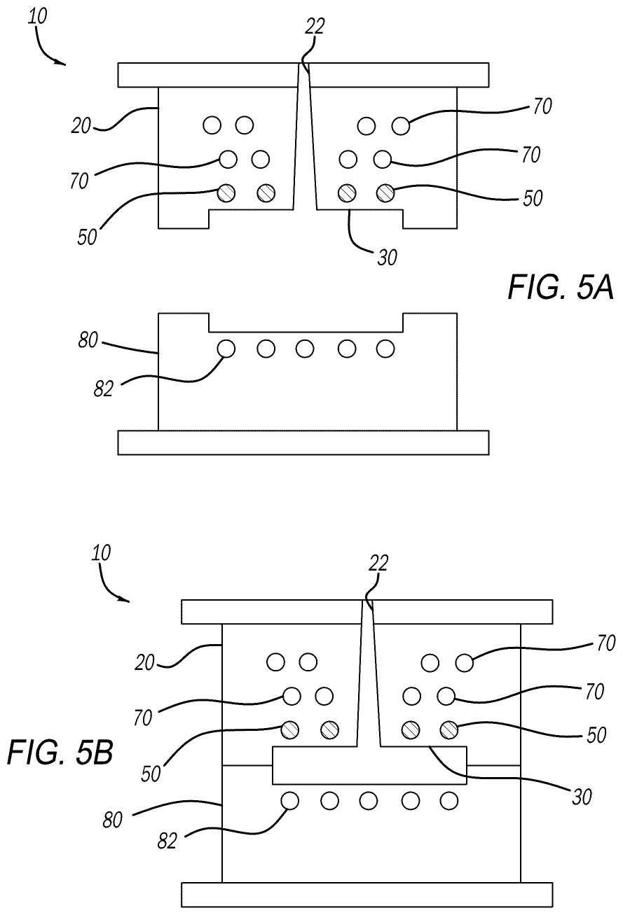

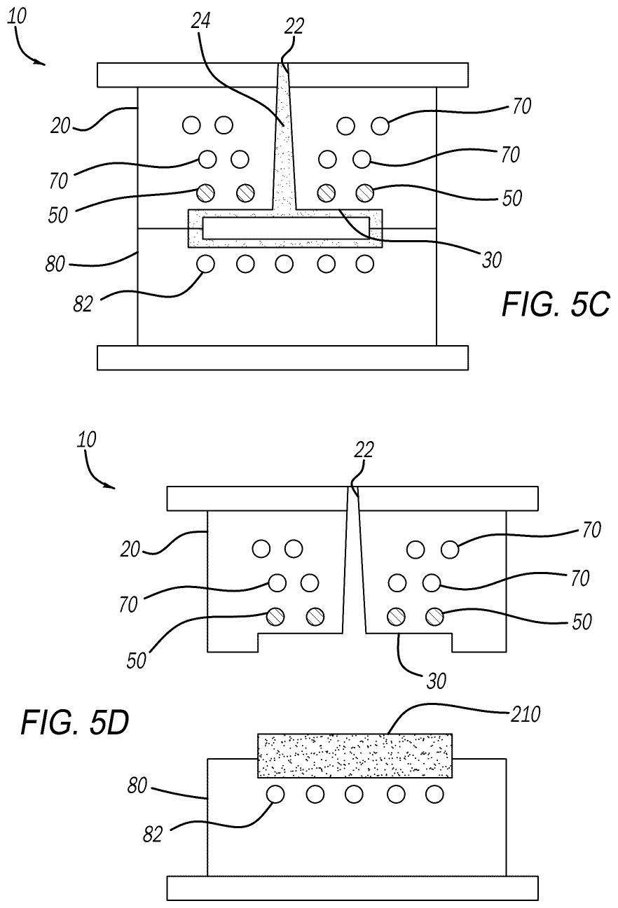

The injection molding system 10 includes a cavity plate 20, which is configured to cooperate with a core plate 80 (see FIGS. 5A-5C) to form the part 210 (or any other suitable part) by plastic injection molding. The cavity plate 20 includes a forming surface 30. The forming surface 30 is configured as a negative of an external side of the part to form an external shape and external features of the part. For example, and with respect to the part 210 of FIG. 6, the forming surface 30 is a negative of an external side 220 of the part 210 configured as a speaker cover.

The forming surface 30 includes various surface features configured to form geometric shapes of the part 210. For example, the forming surface 30 includes first protrusions 32A and second protrusions 32B. In the example illustrated, the first protrusions 32A are arranged closer together than the second protrusions 32B, the second protrusions 32B are outboard of the first protrusions 32A, and the first protrusions 32A are longer than the second protrusions 32B. The first protrusions 32A are configured to form holes extending completely through the part 210. The second protrusions 32B are configured to form second holes of the part, which have a bottom surface and do not extend entirely through the part.

For example, and with respect to the part 210, the first protrusions 32A are configured to form a plurality of first holes 232, which extend entirely through the part 210. The first holes 232 are arranged to cover portions of a speaker. The first holes 232 are clustered together in a generally circular arrangement so as to cover a generally circular speaker. The first protrusions 32A may be arranged in any other suitable configuration as well.

The second protrusions 32B are configured to form a plurality of second holes 234. The second holes 234 have a bottom surface, and thus do not extend entirely through the part 210. The second holes 234 are recesses formed within the external side 220 of the part 210. The second holes 234 are arranged further apart, and are generally outboard of the first holes 232. In some applications, the second holes 234 surround, or partially surround, a grouping of the first holes 232. The second holes 234 are arranged such that the spacing between the second holes 234 generally increases as the second holes 234 extend outward, or generally “fan-out” from the first holes 232. The arrangement of the first protrusions 32A and the second protrusions 32B of the forming surface 30 corresponds to, and is a negative of, the orientation of the first holes 232 and the second holes 234 of the part 210.

The forming surface 30 of the cavity plate 20 further includes a smooth area 40. The smooth area 40 is outboard of the second protrusions 32B. The smooth area 40 is devoid of any surface features that would form holes within the part 210. The smooth area 40 is a negative of a smooth exterior surface 236 of the external side 220 of the part 210.

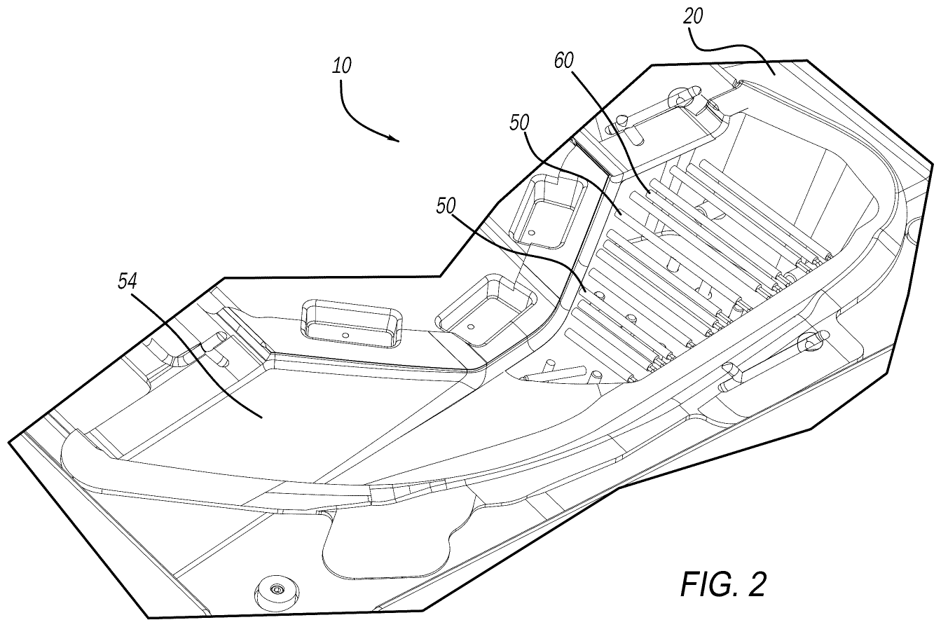

With additional reference to FIGS. 2-4, the cavity plate 20 further includes heaters 50. The heaters 50 are seated in channels 52 defined by the cavity plate 20. The channels 52, and the heaters 50 seated therein, are slightly below the forming surface 30. The heaters 50 are included below the first protrusions 32A and the second protrusions 32B. The heaters 50 are not below the smooth area 40. Thus, the smooth area 40, which is without the first protrusions 32A and the second protrusions 32B, is not heated by the heaters 50. The portion of the cavity plate 20 below the smooth area 40 is devoid of the heaters 50.

The heaters 50 are generally evenly spaced apart by any suitable distance, such as 10.0 mm-15.0 mm, for example. The temperature sensors 60 are spaced apart from the heaters 50 at any suitable distance, such as 4.5 mm-6.0 mm, for example. The heaters 50 are recessed below the forming surface 30 at any suitable distance, such as 6.4 mm-12.0 mm, for example.

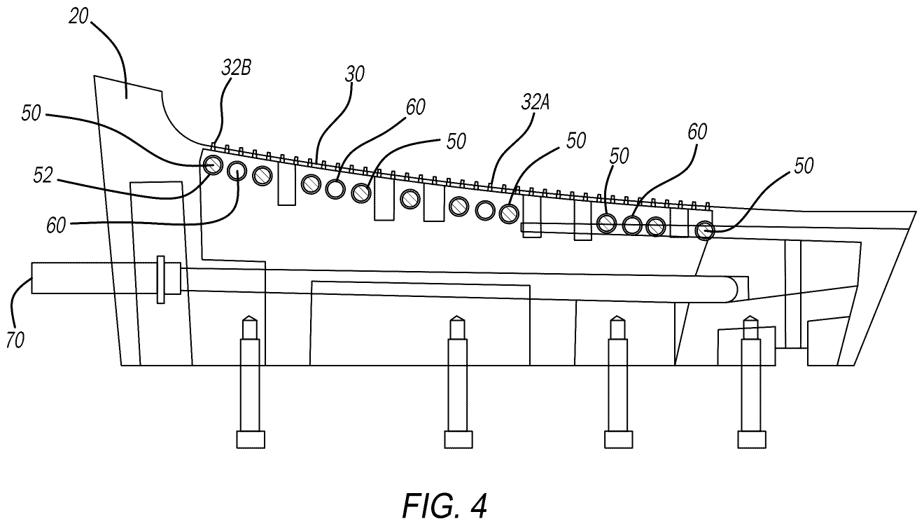

The heaters 50 are any suitable electric heaters. For example, the heaters 50 may be configured as cartridge heaters. The heaters 50 are configured to operate at any suitable temperature, such as within a temperature range of 180 °F-200 °F, or higher. Adjacent to the heaters 50 are temperature sensors 60, which can be configured as any suitable temperature sensors configured to measure temperature of the heaters 50. The temperature sensors 60 may be thermocouples, for example. As illustrated in FIG. 4, for example, the temperature sensors 60 may be arranged between the heaters 50.

The cavity plate 20 includes cooling lines 70 configured to circulate any suitable coolant through the cavity plate 20. For example, the cooling lines 70 may be configured as water conduits. The cooling lines 70 are below the heaters 50 and the temperature sensors 60. The heaters 50 are between the forming surface 30 and the cooling lines 70. The heaters 50 are thus closer to the forming surface 30 than the cooling lines 70.

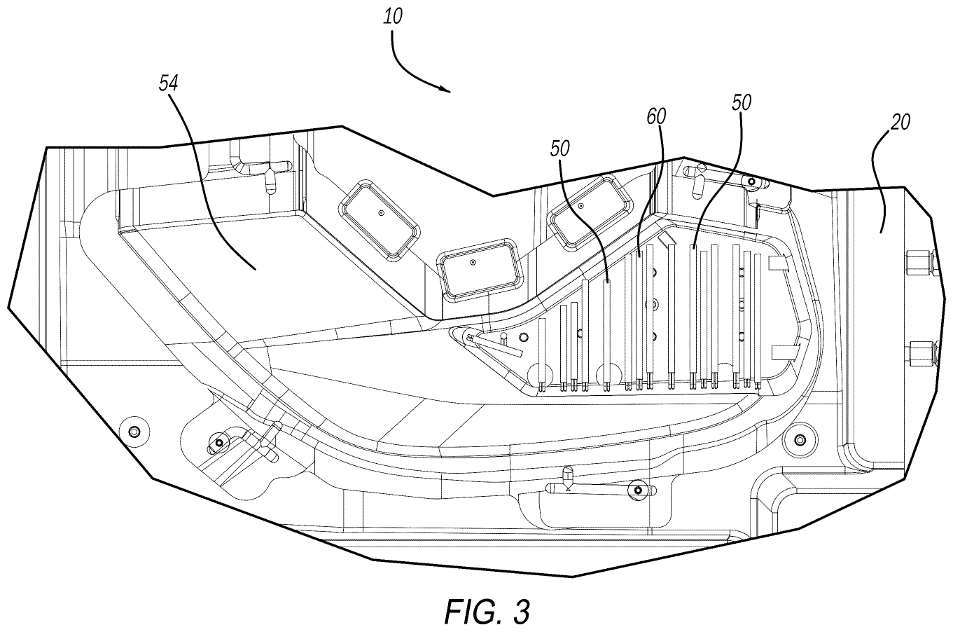

With continued reference to FIGS. 1-4 and 6, and additional reference to FIGS. 5A-5D, an exemplary method for using the injection molding system 10 to form a part, such as the part 210, will now be described. With initial reference to FIG. 5A, the heaters 50 are activated to heat portions of the forming surface 30 including the first protrusions 32A and the second protrusions 32B to any suitable temperature, such as 180 °F-200 °F, or higher. The smooth area 40 is not heated. As explained above, the heaters 50 are arranged opposite to only portions of the forming surface 30 including the first protrusions 32A and the second protrusions 32B. The heaters 50 are not included opposite to the smooth area 40. Therefore, and with reference to FIGS. 2 and 3, there is an area 54 of the cavity plate 20 opposite to the smooth area 40 that is devoid of the heaters 50. As a result, the smooth area 40 of the cavity plate 20 is not heated.

After the forming surface 30 has been heated by the heaters 50, the mold is closed to bring the cavity plate 20 and the core plate 80 together, as illustrated in FIG. 5B. With reference to FIG. 5C, molten plastic is injected into the mold through the gate 22. During the injection process, temperature of the cavity plate 20 is regulated by passing any suitable coolant through the cooling lines 70 of the cavity plate. The core plate 80 also includes cooling lines 82 for cooling the core plate 80.

The molten plastic flows through the gate 22 to the forming surface 30. The molten plastic flows around the first protrusions 32A to form the first holes 232 of the part 210, and flows around the second protrusions 32B to form the second holes 234 of the part 210. The molten plastic also flows to the smooth area 40 to form the smooth exterior surface 236 of the part 210. The molten plastic is then cooled by coolant flowing through the cooling lines 70 of the cavity plate 20 and the cooling lines 82 defined by the core plate 80. With reference to FIG. 5D, after the part 210 is formed, the mold is opened and the part 210 is ejected from the mold.

Heating the portion of the forming surface 30 that includes the first protrusions 32A and the second protrusions 32B eliminates, or at least minimizes, formation of weld lines around the first holes 232 and/or the second holes 234 of the part 210. If the area of the forming surface 30 including the first protrusions 32A and the second protrusions 32B is not heated with the heaters 50, undesirable weld lines may be visible around the first holes 232 or the second holes 234. Without heating, weld lines may be particularly visible around the second holes 234 because they are spaced apart further than the first holes 232.

Eliminating, or at least reducing, the occurrence of weld lines eliminates any need to cover such weld lines with paint. As a result, the part 210 may advantageously be “molded in color” in any color desired by an original equipment manufacturer (OEM), supplier, customer, etc. The forming surface 30 including the first protrusions 32A and the second protrusions 32B is heated to temperatures suitable to facilitate flow of the molten plastic around the first protrusions 32A and the second protrusions 32B, thereby eliminating, or at least minimizing, the formation of weld lines. Heating the forming surface 30 to elevated temperatures within the range of 180 °F to 200 °F, or higher, is typically sufficient to eliminate, or at least reduce, the formation of weld lines. Heating the forming surface 30 to lower temperatures, such as 160 °F, will typically not eliminate, or reduce, the presence of weld lines.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An injection molding system comprising:
a cavity plate configured to cooperate with a core plate to form a part therebetween by injection molding;
a forming surface of the cavity plate configured as a negative of an external side of the part to form an external shape and external features of the part;
cooling lines within the cavity plate; and
heaters within the cavity plate between the forming surface and the cooling lines.

2. The injection molding system of claim 1, further comprising temperature sensors adjacent to the heaters.

3. The injection molding system of claim 2, wherein the temperature sensors are thermocouples.

4. The injection molding system of claim 1, wherein the heaters are electric heaters.

5. The injection molding system of claim 4, wherein the heaters are cartridge heaters.

6. The injection molding system of claim 1, wherein the cavity plate defines a gate configured for molten plastic to be injected through to the forming surface.

7. The injection molding system of claim 1, wherein the forming surface includes surface features configured to form geometric shapes of the part.

8. The injection molding system of claim 7, wherein:
the surface features include a plurality of protrusions; and
the forming surface further includes smooth areas configured to form smooth exterior surfaces of the part.

9. The injection molding system of claim 8, wherein the plurality of protrusions are configured to form a grill pattern of a speaker cover, and the geometric shapes define first holes extending through the part and second holes having a bottom surface.

10. The injection molding system of claim 8, wherein the heaters are restricted to first areas of the cavity plate opposite to the plurality of protrusions such that second areas of the cavity plate opposite to the smooth areas are devoid of the heaters.

11. The injection molding system of claim 1, wherein the heaters are configured to heat to 180 °F-200 °F.

12. An injection molding system comprising:
a cavity plate configured to cooperate with a core plate to form a part therebetween by injection molding;
a forming surface of the cavity plate configured as a negative of an external side of the part, the forming surface including:
protrusions configured to form holes in the part; and
a smooth area spaced apart from the protrusions configured to form a smooth exterior surface of the part spaced from the holes;
cooling lines within the cavity plate; and
heaters within the cavity plate beneath the protrusions, and between the protrusions and the cooling lines, the heaters configured to heat molten plastic injected onto the forming surface during molding.

13. The injection molding system of claim 12, wherein the heaters are configured to heat to within a temperature range of 180 °F-200 °F.

14. The injection molding system of claim 12, further comprising temperature sensors adjacent to the heaters.

15. The injection molding system of claim 14, wherein the temperature sensors include thermocouples.

16. The injection molding system of claim 15, wherein the heaters include cartridge heaters.

17. A method for forming a part by injection molding, the method comprising
heating a forming surface of a cavity plate of a mold assembly with heaters within the cavity plate between the forming surface and cooling lines within the cavity plate;
closing the cavity plate and a core plate of the mold assembly together;
injecting molten plastic through a gate defined by the cavity plate into an area between the cavity plate and the core plate such that the molten plastic flows onto the forming surface and around protrusions of the forming surface to form holes in the part;
cooling the molten plastic with coolant flowing through cooling lines within the cavity plate, the heaters within the cavity plate are between the forming surface and the cooling lines;
separating the cavity plate and the core plate; and
removing the part from the mold assembly.

18. The method of claim 17, further comprising heating the forming surface with the heaters to 180 °F-200 °F.

19. The method of claim 17, further comprising forming the part as a speaker cover.

20. The method of claim 17, further comprising injecting the molten plastic through the gate onto an unheated, smooth area of the forming surface to form a smooth exterior surface of the part spaced apart from the holes in the part.
